(19) United States
(12) Patent Application Publication
(10) Pub. No.: US 2013/0100852 A1
(43) Pub. Date: Apr. 25, 2013

(54) METHOD AND APPARATUS FOR MULTI-HOP QoS ROUTING

(71) Applicant: Electronics and Telecommunications Research In, Daejeon (KR)

(72) Inventors: Young Ae JEON, Daejeon (KR); MINTAE HWANG, Gyeongsangnam-do (KR); KYOHONG JIN, Busan (KR); JINUK JUNG, Busan (KR)

(73) Assignee: Electronics and Telecommunications Research Institute, Daejeon (KR)

(21) Appl. No.: 13/655,669

(22) Filed: Oct. 19, 2012

(30) Foreign Application Priority Data
Oct. 19, 2011 (KR) 10-2011-0107153
Sep. 13, 2012 (KR) 10-2012-0101824

(51) Int. Cl. H04L 12/28

(52) U.S. Cl. 370/254

(57) ABSTRACT

A device within an extended beacon group: generates a neighbor list representing information of each neighbor device corresponding to an 1-hop distance of the device; determines whether a function of the device is as a relaying device using the neighbor list of the device and a neighbor list of the each neighbor device; and selects, when a function of all devices within the extended beacon group is determined, a relaying device to transfer data to the destination device using a metric value representing quality of service (QoS).

### CROSS-REFERENCE TO RELATED APPLICATION

This application claims priority to and the benefit of Korean Patent Application No. 10-2011-0107153 and 10-2012-0101824 filed in the Korean Intellectual Property Office on Oct. 19, 2011 and Sep. 13, 2012, the entire contents of which are incorporated herein by reference.

### BACKGROUND OF THE INVENTION

(a) Field of the Invention

The present invention relates to a method and apparatus for routing. More particularly, the present invention relates to a method and apparatus for QoS routing for distributed medium access control (DMAC)-based multi-hop communication.

(b) Description of the Related Art

WiMedia is a high speed wireless personal area network (WPAN) standard that provides a maximum data rate of 480 Mbps in a 3.1-10.6 GHz band, provides a faster transmission speed than other wireless communication technologies, and is thus appropriate for multimedia data transmission that requires a high speed data rate.

WiMedia-based high speed WPAN technology connects an audio/video apparatus, a computer, and a peripheral device existing at a short range within a single beacon group using wireless, and supports communication between small multimedia devices that can conveniently carry signals with low power and is thus technology that can support various services. Such high speed wireless communication technology has been standardized by the WiMedia alliance.

WiMedia provides a high speed data rate, but a maximum transmission range is very limited at 10 m. Therefore, devices existing at a distance of 10 m or more should set a path through multi-hop routing to transmit/receive data. However, a present WiMedia standard does not provide such a multi-hop routing function.

For example, when a plurality of beacon groups are combined to form one extended beacon group, direct communication may not be performed from a starting point device to a destination device within the extension beacon group. Therefore, in order for WiMedia-based high speed WPAN technology to have competitive power in a market, the extension of a transmission range by multi-hop routing is essential.

Further, when considering that a major application field of a high speed WPAN is a real-time multimedia service, upon developing a multi-hop routing algorithm, quality of service (QoS) guarantees such as delay time, frame loss rate, and bandwidth should be preferentially considered. Therefore, a routing method that can guarantee QoS while providing a multi-hop routing function in a WiMedia-based high speed WPAN is important.

### SUMMARY OF THE INVENTION

The present invention has been made in an effort to provide a method and apparatus for multi-hop QoS routing having advantages of guaranteeing QoS while providing a multi-hop routing function in a WiMedia-based high speed WPAN.

An exemplary embodiment of the present invention provides a method of routing from a starting point device to a destination device in a first device within an extended beacon group. The method includes: generating a neighbor list (NL) of the device representing information of each neighbor device corresponding to a 1-hop distance of the device; determining whether a function of the device is as a relaying device using the NL of the device and an NL of the each neighbor device; and selecting, when a function of all devices within the extended beacon group is determined, a relaying device to transfer data to the destination device using a metric value representing quality of service (QoS).

The generating of an NL may include receiving a beacon frame from each neighbor device, and generating the NL using a source address of the beacon frame.

The beacon frame may include an NL information element (NLIE), and the NLIE may include an NL of the neighbor device.

The NLIE may include a relaying device subfield representing a function of the neighbor device, and a medium access slot (MAS) field representing the number of MASs that the neighbor device can use.

The NLIE may further include a hop count subfield representing a hop count from a device that generates the NLIE to a device that receives the NLIE, and the hop count may increase by 1 whenever passing through a relaying device.

The selecting of a relaying device may include: calculating a metric value of each of neighbor devices corresponding to a relaying device using an available MAS number, a received signal strength indication (RSSI) according to a transmission distance, and a hop count; and selecting a neighbor device having a largest metric value among neighbor devices corresponding to the relaying device as the relaying device to transfer the data.

The method may further include relaying, when the device is a relaying device, a beacon frame that is received from the each neighbor device to the neighbor device of the 1-hop distance.

The determining of whether a function of the device is as a relaying device may include: obtaining difference sets of the NL of the device and the NL of the each neighbor device; and determining, when all difference sets of the NL and the NL of each neighbor device are a null set, that a function of the device is as a relaying device.

The method may further include generating an NLIE including the NL of the device, and transmitting the NLIE at a next superframe through a beacon frame including the NLIE.

The generating of an NLIE may include generating the NLIE when the generated NL is changed.

Another embodiment of the present invention provides a multi-hop QoS routing apparatus from a starting point device to a destination device of devices within an extended beacon group. The multi-hop QoS routing apparatus includes a routing table, a beacon receiving unit, a routing controller, and a data transmitting unit. The routing table includes a destination address field, a next hop address field, and an available MAS number field. The beacon receiving unit receives a beacon frame from each neighbor device of a 1-hop distance. The routing controller records a source address of the received beacon frame at the destination address field and the next hop address field of the routing table, records an address of a neighbor device of a 2-hop distance that is determined from the received beacon frame at a destination address field, and records a next hop address as a source address of the beacon frame. The data transmitting unit selects a relaying device to transmit data to the destination device with reference to the routing table. The beacon frame includes an NL representing information of a neighbor device of a 1-hop distance of a neighbor device of the 1-hop distance.

The multi-hop QoS routing apparatus may further include an NLIE generator and a beacon transmitting unit. The NLIE generator may generate an NL of the device from a beacon frame that is received from the neighbor device and generate an NLIE including the NL. The beacon transmitting unit may transmit a beacon frame including the NLIE at an allocated MAS of a beacon period to a neighbor device of the 1-hop distance.

The multi-hop QoS routing apparatus may further include a function determining unit. The function determining unit may determine whether a function of the device is as a relaying device using an NL of the device and an NL of a neighbor device of the 1-hop distance. The NLIE may include a relaying device subfield representing a function of the device.

The function determining unit may determine that the device is a relaying device when all difference sets of the NL of the device and the NL set of each neighbor device of the 1-hop distance are null sets.

The NLIE generator may generate the NLIE when the NL is changed, and the beacon transmitting unit may transmit the received beacon frame to a neighbor device of the 1-hop distance when the device is a relaying device.

The routing table may further include a metric field, and the routing controller may calculate a metric value of each of neighbor devices corresponding to a relaying device using RSSI according to a transmission distance of each of neighbor devices, a hop count, and the available MAS number and records the metric value in the metric field, and selects a neighbor device having a largest metric value among neighbor devices corresponding to the relaying device as a relaying device to transfer the data.

### BRIEF DESCRIPTION OF THE DRAWINGS

FIG. 1 is a diagram illustrating a structure of a superframe of a DMAC-based high speed wireless communication network according to an exemplary embodiment of the present invention.

FIG. 2 is a diagram illustrating a single beacon group of a DMAC-based high speed wireless communication network according to an exemplary embodiment of the present invention.

FIG. 3 is a diagram illustrating an extended beacon group of a DMAC-based high speed wireless communication network according to an exemplary embodiment of the present invention.

FIG. 4 is a diagram illustrating a network model for explaining a method of selecting a relaying device according to an exemplary embodiment of the present invention.

FIG. 5 is a diagram illustrating a beacon period for explaining a method of selecting a relaying device according to an exemplary embodiment of the present invention.

FIG. 6 is a flowchart illustrating a routing method using a relaying device within an extended beacon group according to an exemplary embodiment of the present invention.

FIG. 7 is a diagram illustrating an example of a method in which a device receives a beacon frame from a neighbor device at a 1-hop distance in a network model that is shown in FIG. 4.

FIG. 8 is a diagram illustrating an example of a routing table in which a device generates in a network model that is shown in FIG. 4.

FIG. 9 is a diagram illustrating an NLIE according to an exemplary embodiment of the present invention.

FIG. 10 is a diagram illustrating an example of a method in which a device receives a beacon frame including an NLIE from a neighbor device at a 1-hop distance in a network model that is shown in FIG. 4.

FIGS. 11A and 11B are diagrams illustrating an example of a method of determining a function of a device within an extended beacon group that is shown in FIG. 4.

FIG. 12 is a diagram illustrating a portion of a routing table of a device within an extended beacon group that is shown in FIG. 4.

FIG. 13 is a diagram illustrating a data rate change according to a distance within a beacon group of a WiMedia network.

FIG. 14 is a flowchart illustrating a method in which a device selects a relaying device according to an exemplary embodiment of the present invention.

FIG. 15 is a diagram illustrating an example of metric that is calculated according to a destination address when a device within an extended beacon group that is shown in FIG. 4 transfers data to a random destination device.

FIG. 16 is a flowchart illustrating a method of transmitting an NLIE in a device according to an exemplary embodiment of the present invention.

FIG. 17 is a block diagram illustrating a configuration of a routing apparatus according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, in the entire specification and claims, unless explicitly described to the contrary, the word “comprise” and variations such as “comprises” or “comprising” will be understood to imply the inclusion of stated elements but not the exclusion of any other elements.

Hereinafter, a method and apparatus for routing a multi-hop QoS according to an exemplary embodiment of the present invention will be described in detail with reference to the drawings.

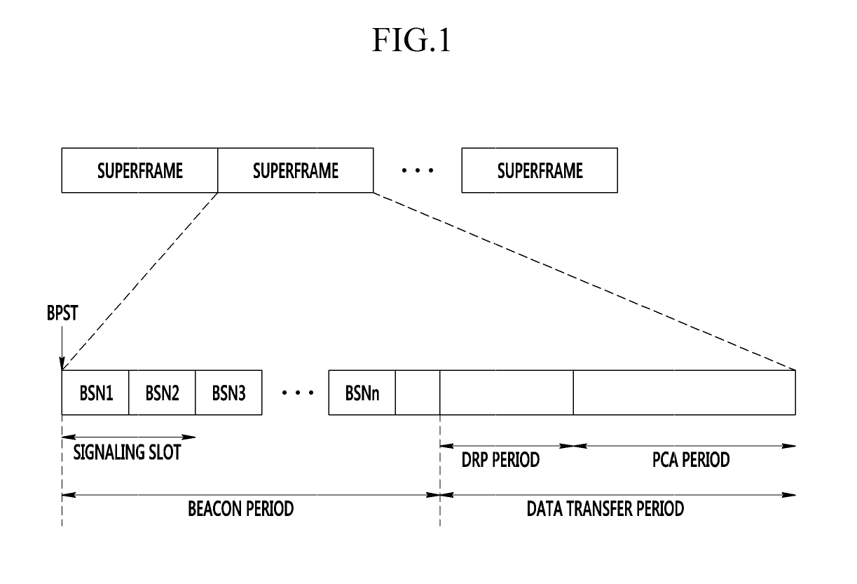

FIG. 1 is a diagram illustrating a structure of a superframe of a DMAC-based high speed wireless communication network according to an exemplary embodiment of the present invention.

Referring to FIG. 1, each superframe includes a beacon period and a data transfer period, and the beacon period and the data transfer period include a plurality of medium access slots (MAS).

The superframe is started at the beacon period, and the beacon period is divided into beacon slots. Beacon slot numbers BSN1-BSNn are allocated to the beacon slot, and such beacon slots are allocated to devices corresponding thereto.

A start time point of a first beacon slot of the beacon period is referred to as a beacon period start time (BPST), and a beacon slot of the first predetermined number (e.g., two) of the beacon period is referred to as a signaling slot.

The data transfer period includes a distributed reservation protocol (DRP) period and a prioritized contention access (PCA) period.

The DRP period is a period in which a device reserves and exclusively uses a specific channel time, and at the DRP period, the device uses a time division multiple access (TDMA) method appropriate for real-time traffic transmission that requires quality of service (QoS). In this case, a reserved time unit is referred to as a medium access slot (MAS).

At the PCA period, the device transmits data using an enhanced distributed channel access (EDCA) method of carrier sense multiple access with collision avoidance (CSMA/CA)-based IEEE 802.11e.

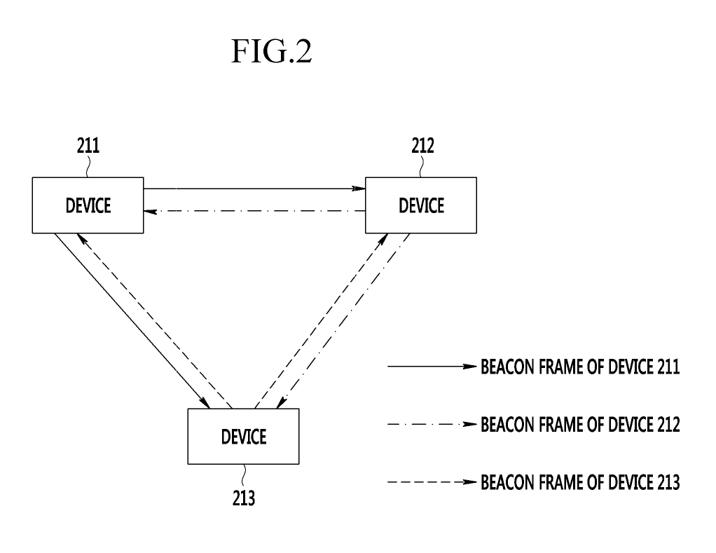

FIG. 2 is a diagram illustrating a single beacon group of a DMAC-based high speed wireless communication network according to an exemplary embodiment of the present invention.

Referring to FIG. 2, a plurality of devices 211, 212, and 213 transmit a beacon frame at a beacon slot that is allocated thereto within the beacon period, and receive a beacon frame in which other devices transmit at other beacon slots.

When transmitting a beacon frame, the plurality of devices 211, 212, and 213 include information about the device and a network in an information element (IE) and transfer the IE to neighbor devices. Because the plurality of devices 211, 212, and 213 transmit/receive a beacon frame including the IE at every beacon period, the plurality of devices 211, 212, and 213 can always quickly update information about peripheral devices.

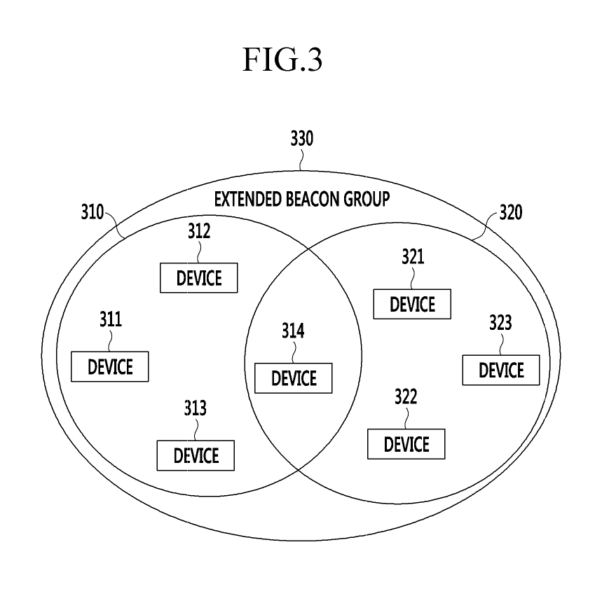

FIG. 3 is a diagram illustrating an extended beacon group of a DMAC-based high speed wireless communication network according to an exemplary embodiment of the present invention.

Referring to FIG. 3, in WiMedia, a set of devices that exist within a range that can perform direct communication and that use the same BPST is defined as a beacon group. For example, when a beacon group 310 is formed with devices 311, 312, 313, and 314, and when a beacon group 320 is formed with devices 321, 322, and 323, the devices 311, 312, 313, and 314 use the same BPST, and the devices 321, 322, and 323 also use the same BPST. In this case, as shown in FIG. 3, when the beacon group 320 moves to a periphery of the beacon group 310, the device 314 belongs to the beacon group 310 and the beacon group 320. Therefore, the beacon group 310 and the beacon group 320 are combined using the device 314 as an intermediary and form one extended beacon group 330 that uses one BPST.

In this way, when two beacon groups 310 and 320 are combined, the device 311 may know that the devices 321, 322, and 323 exist within the extension beacon group 330 through a beacon frame that is transmitted by the device 314, but because a WiMedia standard does not provide multi-hop communication, data cannot be transmitted to the devices 321, 322, and 323.

Therefore, in order for the device 311 to communicate with the devices 321, 322, and 323 existing at a distance of 2 hops or more, a device existing between two beacon groups 310 and 320 should relay data like the device 314. In this way, a device that relays data between the two beacon groups 310 and 320 is referred to as a relaying device.

Therefore, the device 311 within the beacon group 310 can perform multi-hop communication with the external device 321 within the beacon group 320 using the device 314 that also belongs to another beacon group 320 as an intermediary, and thus two devices within different beacon groups can perform multi-hop communication.

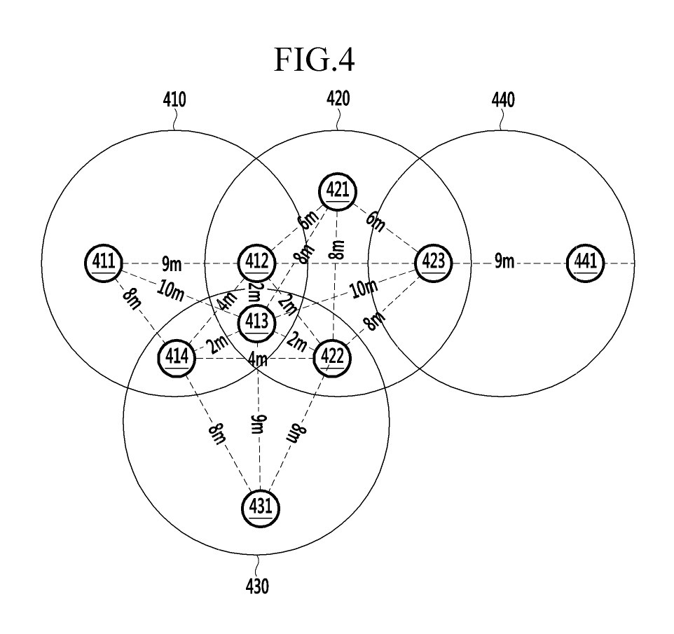

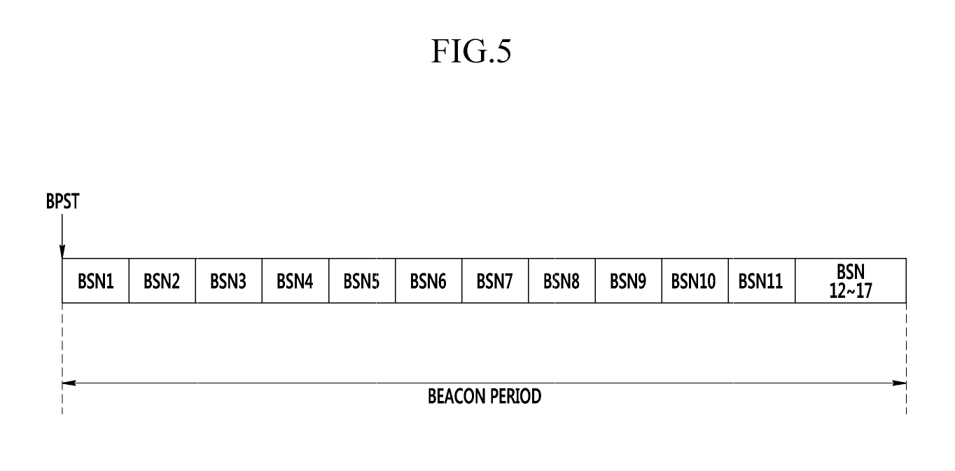

FIG. 4 is a diagram illustrating a network model for explaining a method of selecting a relaying device according to an exemplary embodiment of the present invention, and FIG. 5 is a diagram illustrating a beacon period for explaining a method of selecting a relaying device according to an exemplary embodiment of the present invention.

As shown in FIG. 4, four beacon groups 410, 420, 430, and 440 are formed into one extension beacon group, and it is assumed that a distance between devices is a maximum of 10 m and a minimum of 2 m. One superframe is formed with 256 MASs having a length of 256 μsec, and the number of the remaining MASs, except for a length of the beacon period among 256 MASs, may be used at a data transfer period.

As shown in FIG. 5, the first two beacon slot numbers BSN1 and BSN2 of the beacon period are allocated to a signaling slot, and subsequent beacon slot numbers BSN3-BSN17 are used when each device transmits a beacon frame. In a network model of FIG. 4, beacon slot numbers BSN3-BSN11 after the beacon slot numbers BSN1 and BSN2 are allocated to devices 411, 412, 413, 414, 421, 422, 423, 431, and 441 within an extended beacon group.

The devices 411, 412, 413, 414, 421, 422, 423, 431, and 441 within the extended beacon group transmit a beacon frame at a beacon slot that is allocated thereto within the beacon period, and receive a beacon frame in which other devices transmit at other beacon slots.

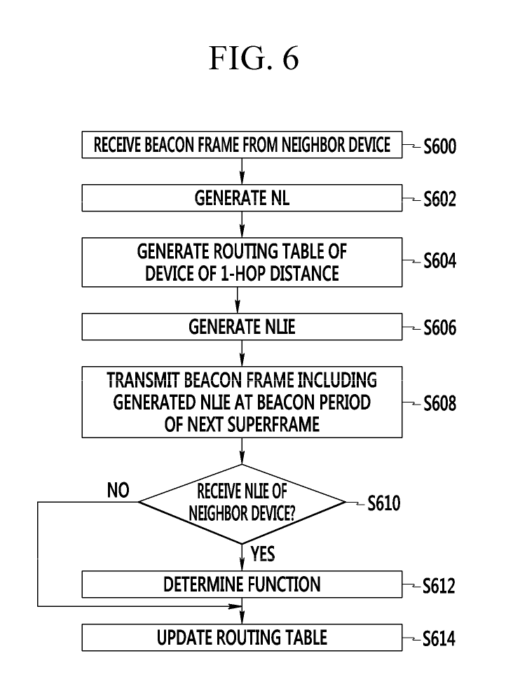

Next, a method and apparatus for routing using a relaying device when direct communication is unavailable from a starting point device to a destination device within an extended beacon group such as FIG. 4 will be described with reference to FIGS. 6 to 17.

FIG. 6 is a flowchart illustrating a routing method using a relaying device within an extended beacon group according to an exemplary embodiment of the present invention.

Referring to FIG. 6, each of the devices 411, 412, 413, 414, 421, 422, 423, 431, and 441 within an extended beacon group receives a beacon frame from a neighbor device at an 1-hop distance for a beacon period (S600), and generates an NL including addresses thereof (S602).

The devices 411, 412, 413, 414, 421, 422, 423, 431, and 441 generate a routing table of a device of a 1-hop distance using a value of a source field of the received beacon frame (S604). The devices 411, 412, 413, 414, 421, 422, 423, 431, and 441 record a value of a source field including an address of a device that transmits the received beacon frame in a destination address field and a next hop address field of the routing table and thus generate a routing table of a device of a 1-hop distance.

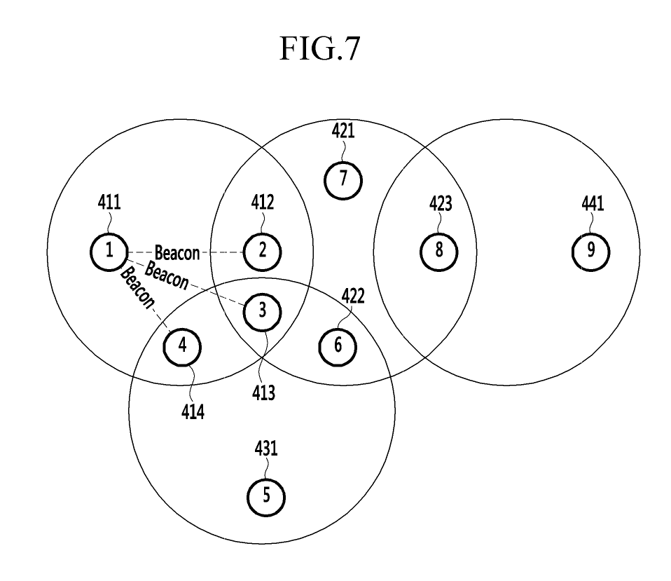

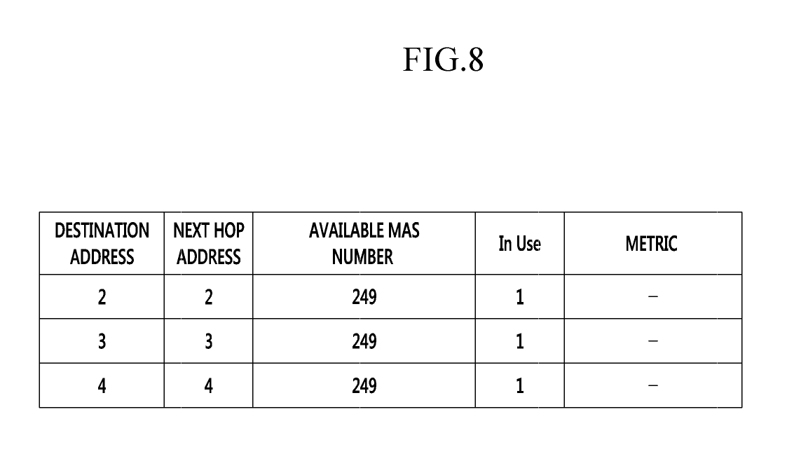

FIG. 7 is a diagram illustrating an example of a method in which a device receives a beacon frame from a neighbor device at an 1-hop distance in a network model that is shown in FIG. 4, and FIG. 8 is a diagram illustrating an example of a routing table in which a device generates in a network model that is shown in FIG. 4.

As shown in FIG. 7, when addresses of the devices 411, 412, 413, 414, 421, 422, 423, 431, and 441 are 1, 2, 3, 4, 7, 6, 8, 5, and 9, respectively, the device 411 receives a beacon frame from neighbor devices 412, 413, and 414 and generates an NL {1, 2, 3, 4}. That is, a neighbor list NL₁ of the device 411 is as follows.

NL₁={1, 2, 3, 4}

Next, the device 411 generates a routing table of FIG. 8 from a beacon frame that it receives from the neighbor devices 412, 413, and 414. That is, when the device 411 receives a beacon frame from the neighbor device 412, the device 411 records 2, which is an address of the neighbor device 412 corresponding to a value of a source field of the beacon frame at a destination address field and a next hop address field. When the device 411 receives a beacon frame from the neighbor device 413, the device 411 records an address 3 of the neighbor device 413, which is a value of a source field of the beacon frame at a destination address field and a next hop address field. Further, when the device 411 receives a beacon frame from the neighbor device 414, the device 411 records an address 4 of the neighbor device 414, which is a value of a source field of the beacon frame at a destination address field and a next hop address field. In available relaying devices from a transmission device to a destination device, a relaying device having a highest value through metric calculation sets a value of an In Use field to 1, and a relaying device having other values sets a value of an In Use field to 0. Metric calculation will be described later.

In this way, the device 411 generates a routing table of the neighbor devices 412, 413, and 414.

In this way, other devices 412, 413, 414, 421, 422, 423, 431, and 441 within the extended beacon group receive a beacon frame from devices at a 1-hop distance therefrom for a beacon period, generate an NL, and generate a routing table.

Referring again to FIG. 6, the devices 411, 412, 413, 414, 421, 422, 423, 431, and 441 generate a neighbor list information element (NLIE) for transferring the generated NL to a neighbor device (S606).

In this way, for a beacon period, an NL of each of the devices 411, 412, 413, 414, 421, 422, 423, 431, and 441 is generated, and the devices 411, 412, 413, 414, 421, 422, 423, 431, and 441 generate an NLIE using the NL. The NLIE includes available MAS information and hop count information as well as information about neighbor devices. Here, the available MAS information and the hop count information are used as a measure in which a device that receives an NLIE selects a relaying device.

Only when an NL is first generated or only when an NL thereof is changed due to addition or deletion of a new device do the devices 411, 412, 413, 414, 421, 422, 423, 431, and 441 generate and transmit an NLIE. The relaying device relays an NLIE in which another relaying device transmits.

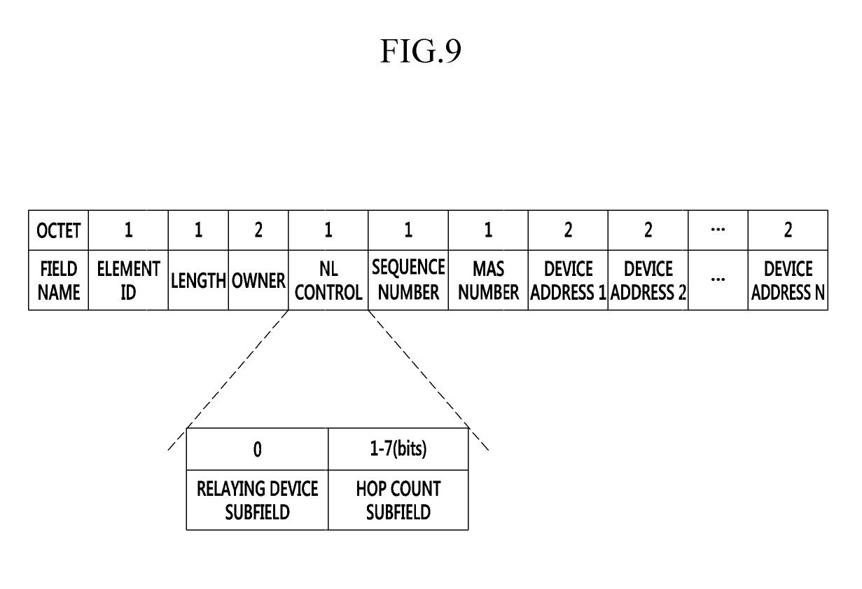

FIG. 9 is a diagram illustrating an NLIE according to an exemplary embodiment of the present invention.

Referring to FIG. 9, the NLIE includes an element identifier (ID) field, a length field, an owner field, an NL control field, a MAS field, and a plurality of device fields.

The element ID field represents an ID using for distinguishing an NLIE and may be 1 byte (i.e., octet).

The length field represents a length of an NLIE, except for an element ID field and a length field, and may be 1 byte.

The owner field represents an address of a device that generates an NLIE and may be 2 bytes.

The NL control field includes a relaying device subfield and a hop count subfield. The relaying device subfield is a portion that displays a function of a device that generates an NLIE, and 0 represents a general device while 1 represents a relaying device. The hop count subfield represents a hop count, and the hop count represents how far a device that receives an NLIE is separated from a device that generates an NLIE. A value of the hop count subfield is initially set to 1 and increases by 1 whenever the hop count passes through the relaying device.

The beacon frame includes a distributed reservation protocol information element (DRP IE) that is used for reserving a channel for a specific time as well as an NLIE. The DRP IE includes a DRP control, a DRP target/owner address, and a DRP allocation field, and the DRP allocation field represents MAS information that a present neighbor device uses.

In the NLIE, the MAS field represents the available MAS number, and a value of the MAS field may be calculated using a DRP allocation field of the above-described DRP IE and may be 1 byte.

The plurality of device fields represent an address of neighbor devices of a device that transmits an NLIE and may each be 2 bytes.

Referring to FIG. 6, the devices 411, 412, 413, 414, 421, 422, 423, 431, and 441 generate an NLIE in a present superframe and transmit a beacon frame including an NLIE thereof at a beacon slot that is allocated to them within a beacon period of a next superframe (S608).

In this way, when the devices 411, 412, 413, 414, 421, 422, 423, 431, and 441 transmit a beacon frame including an NLIE at a beacon slot that is allocated thereto within a beacon period of a next superframe, they receive a beacon frame including an NLIE of neighbor devices at a beacon slot other than a beacon slot that is allocated thereto.

The devices 411, 412, 413, 414, 421, 422, 423, 431, and 441 determine whether they receive an NLIE of a neighbor device through a beacon frame from the neighbor device (S610), and if they receive an NLIE of a neighbor device through a beacon frame from the neighbor device, they determine a function that they are to perform using an NLIE of the neighbor device (S612). The devices 411, 412, 413, 414, 421, 422, 423, 431, and 441 obtain the difference sets of an NL thereof and an NL that is received from a neighbor device at a 1-hop distance, and if all results are null sets, they are general devices, and if results are not null sets, they are relaying devices.

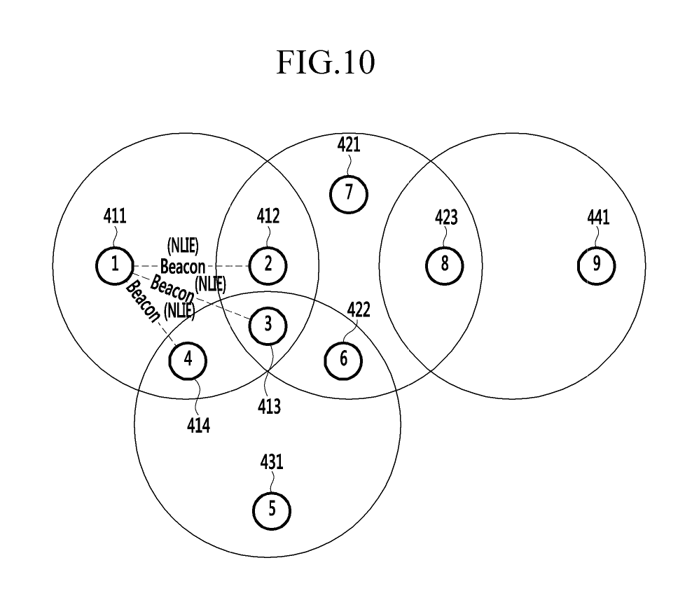

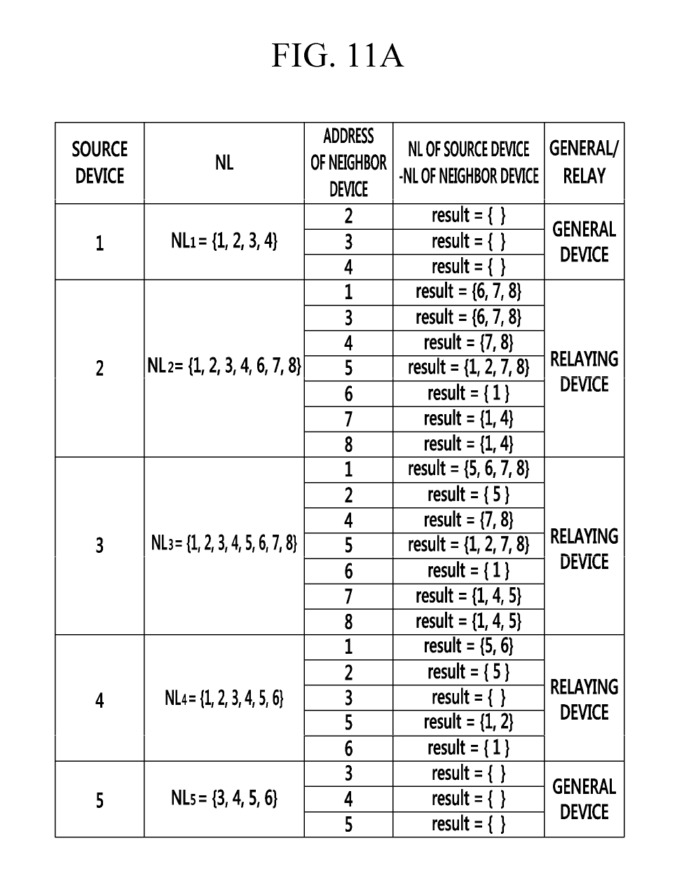

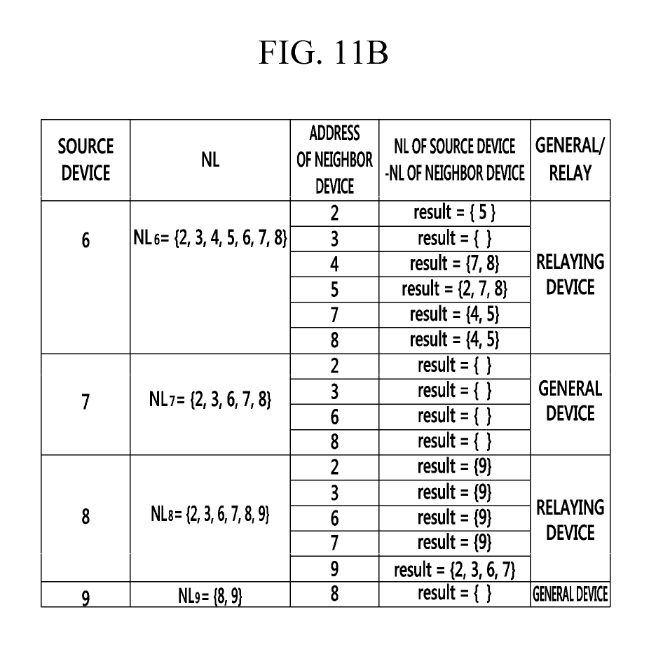

FIG. 10 is a diagram illustrating an example of a method in which a device receives a beacon frame including an NLIE from a neighbor device at an 1-hop distance in a network model that is shown in FIG. 4, and FIGS. 11A and 11B are diagrams illustrating an example of a method of determining a function of a device within an extended beacon group that is shown in FIG. 4.

Referring to FIG. 10, as the device 411 receives a beacon frame including an NLIE of the devices 412, 413, and 414 from each of the devices 412, 413, and 414, the device 411 determines an NL of the devices 412, 413, and 414. NLs (NL₂, NL₃, and NL₄) of the devices 411, 412, and 414 are as follows.

NL₂={1, 2, 3, 4, 6, 7, 8}

NL₃={1, 2, 3, 4, 5, 6, 7, 8}

NL₄={1, 2, 3, 4, 5, 6}

The device 411 obtains the difference set of an NL₁ and an NL₂, obtains the difference set of an NL₁ and an NL₃, and obtains the difference sets of an NL₁ and an NL₄. In this case, because all results become null sets, the device 411 determines that it is a general device.

In a similar method, as shown in FIGS. 11A and 11B, the remaining devices 412, 413, 414, 421, 422, 423, 431, and 441 obtain the difference sets of an NL thereof and a received NL of each of neighbor devices and determine whether they are general devices or relaying devices. Referring to FIGS. 11A and 11B, the devices 412, 413, 414, 422, and 423 determine that they are relaying devices.

In this way, when a function of the devices 411, 412, 413, 414, 421, 422, 423, 431, and 441 is determined, they update a routing table of a neighbor device of a 1-hop distance (S614). The devices 411, 412, 413, 414, 421, 422, 423, 431, and 441 compare a value of a source field of the received beacon frame and a value of an owner field of an NLIE, and if values of two fields are the same, they determine that a neighbor device of an 1-hop distance has been generated and transmitted an NLIE. Further, the devices 411, 412, 413, 414, 421, 422, 423, 431, and 441 determine an NL of the neighbor device and thus determine a neighbor device of a 2-hop distance. Therefore, the devices 411, 412, 413, 414, 421, 422, 423, 431, and 441 each record an address that is recorded at a plurality of device fields of an NLIE that is received from the neighbor device at a destination address field of a routing table, and set a next hop address as a value of a source field of a received beacon frame.

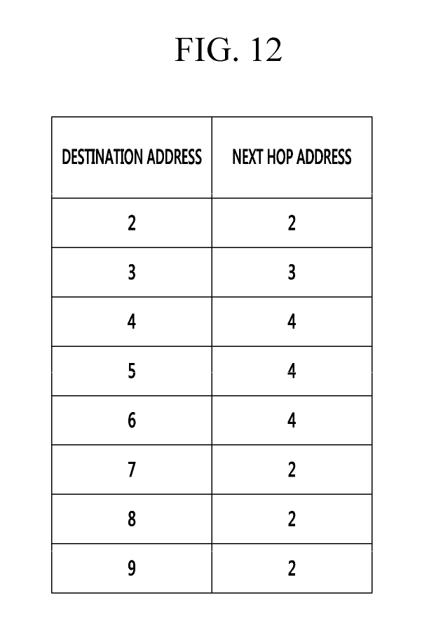

For example, the device 411 updates a routing table through a beacon frame that it receives from the neighbor devices 412, 413, and 414, as shown in FIG. 12.

FIG. 12 is a diagram illustrating a portion of a routing table of a device within an extended beacon group that is shown in FIG. 4, and the device 411 determines that neighbor devices 421, 422, 423, 431, and 441 of the neighbor devices 412, 413, and 414 exist through a beacon frame that it receives from the neighbor devices 412, 413, and 414, records each of addresses of the neighbor devices 421, 422, 423, 431, and 441 of the neighbor devices 412, 413, and 414 at a destination address field, and records an address of the neighbor devices 412 and 414, which is a value of a source field of the received beacon frame, at a next hop address field. Thereby, the device 411, having received {1, 2, 3, 4, 6, 7, 8}, which is an NL₂ of the device 412, selects an address of the device 412 to a next hop of the remaining devices, except for the device 411, with reference to a routing table.

If a beacon frame from a neighbor device does not include an NLIE at step S610, the devices 411, 412, 413, 414, 421, 422, 423, 431, and 441 are not related to determination of a function thereof and thus immediately update the routing table (S614).

Such steps S600-S614 are performed until the beacon period is terminated.

When the beacon period is terminated, the devices 411, 412, 413, 414, 421, 422, 423, 431, and 441 transmit a beacon frame including an NLIE thereof with the same method as the above-described method at an allocated beacon slot within a beacon period of a next superframe.

The device 411 may have many relaying devices for one destination. For example, when the devices 412, 413, and 414 transfer data that is transmitted by the device 411 to the device 422, the device 411 should select one of the devices 412, 413, and 414 as a relaying device and transmit data.

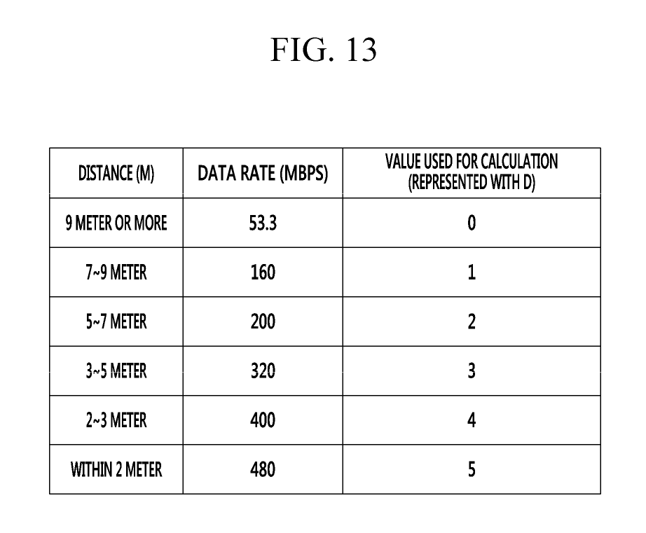

FIG. 13 is a diagram illustrating a data rate change according to a distance within a beacon group of a WiMedia network. As can be seen in FIG. 13, a distance between devices strongly affects a data rate. Such a data rate is proportional to received signal strength indication (RSSI).

In an exemplary embodiment of the present invention, the available MAS number N_{HASs}, RSSI, and a hop count N_{HC} are used as parameters for selecting an optimal relaying device that guarantees QoS.

When the number of MASs that are required by a source device that transmits data is basically satisfied, QoS can be guaranteed and thus the available MAS number N_{HASs} among the available MAS number N_{HASs}, RSSI, and a hop count N_{HC} may be the most important parameter. When the device receives a beacon frame or a data frame, RSSI may be measured, and this is a basic function in which WiMedia provides. As shown in FIG. 13, as a distance between devices decreases, a higher transmission speed is provided, and as the data rate is proportional to RSSI, when selecting a relaying device, such a transmission distance D may be used as an RSSI parameter.

The hop count N_{HC} is included in an NLIE, and when the hop count N_{HC} passes through many relaying devices, much time is consumed in transferring data and thus the relaying device may be selected to have a small hop count value.

The devices 411, 412, 413, 414, 421, 422, 423, 431, and 441 calculate a metric for selecting a relaying device using a value of such three parameters N_{HASs}, D, and N_{HC} as in Equation 1.

$$Metric = \frac{( α \times {N}_{MASs} ) + ( β \times D )}{{N}_{HC}} \qquad [ Equation 1 ]$$

In Equation 1, α and β represent weight values that are applied to the parameters, and the sum of the weight values is 1. In this case, in order to guarantee QoS, the available MAS number N_{HASs} is the most important parameter and thus a may be set to be larger than β.

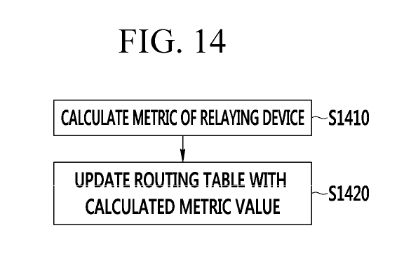

FIG. 14 is a flowchart illustrating a method in which a device selects a relaying device according to an exemplary embodiment of the present invention.

Referring to FIG. 14, the devices 411, 412, 413, 414, 421, 422, 423, 431, and 441 calculate a metric of a relaying device based on Equation 1 using a value of parameters N_{HASs}, Dm, and N_{HC} (S1410).

The devices 411, 412, 413, 414, 421, 422, 423, 431, and 441 update a routing table with the calculated metric value (S1420).

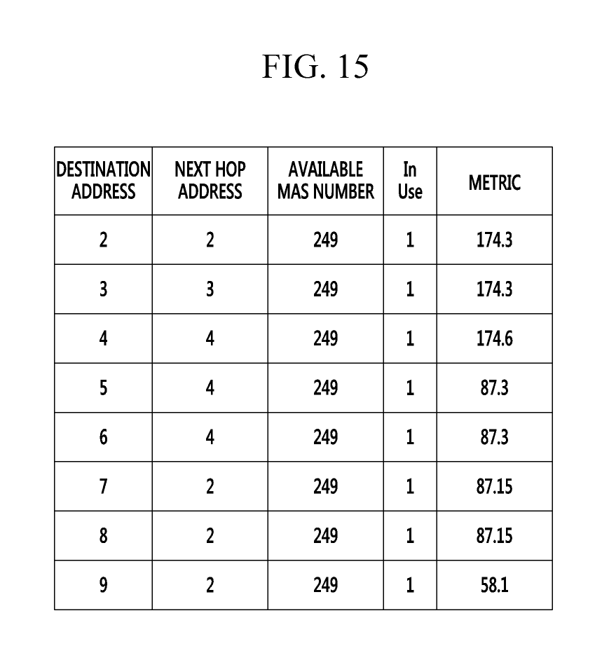

FIG. 15 is a diagram illustrating an example of a metric that is calculated according to a destination address when a device within an extended beacon group that is shown in FIG. 4 transfers data to a random destination device. In this case, α and β are set to 0.7 and 0.3, respectively.

As shown in FIG. 15, the device 411 calculates the metric of the relaying device based on Equation 1 and updates the routing table with the calculated metric.

Thereafter, when transmitting data to each destination device, the device 411 selects a relaying device to use based on a routing table that is shown in FIG. 15. For example, when an address of the destination device is 5, the device 411 may select a device having an address of 4 as a relaying device.

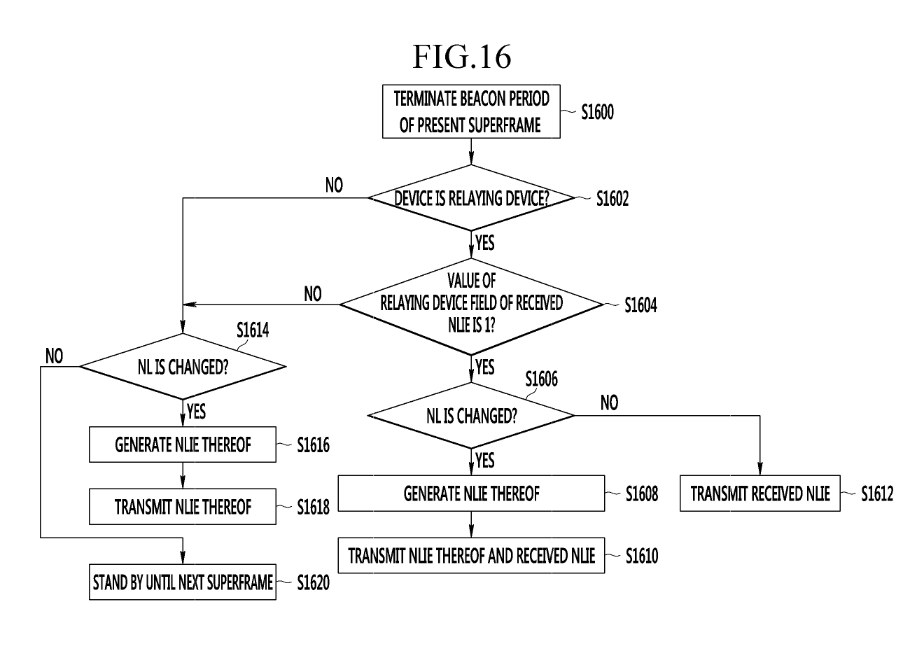

FIG. 16 is a flowchart illustrating a method of transmitting an NLIE in a device according to an exemplary embodiment of the present invention.

Referring to FIG. 16, the devices 411, 412, 413, 414, 421, 422, 423, 431, and 441 determine a function of a device thereof and update a routing table using a beacon frame that is received for a beacon period based on the above-described method.

Next, when the beacon period is terminated, the devices 411, 412, 413, 414, 421, 422, 423, 431, and 441 determine whether an NL that is generated for a present superframe is changed.

The devices 411, 412, 413, 414, 421, 422, 423, 431, and 441 determine an NLIE to transmit at a next superframe according to a function of a device, a value of a relaying device field of an NLIE, and whether an NL is changed.

The device 411 will be described in detail as an example.

When a beacon period of a present superframe is terminated (S1600), the device 411 determines whether it is a relaying device (S1602).

If the device 411 is a relaying device, it determines whether a value of a relaying device field of the received NLIE is 1 (S1604). If a value of a relaying device field of the received NLIE is 1, the device 411 determines whether an NL thereof is changed (S1606). If an NL thereof is changed, the device 411 generates an NLIE thereof (S1608), and includes the NLIE thereof and the received NLIE in a beacon frame and transmits the beacon frame at an allocated beacon slot within the beacon period of a next superframe (S1610).

If an NL thereof is not changed at step S1606, it includes only the received NLIE in the beacon frame and transmits the beacon frame at an allocated beacon slot within a beacon period of a next superframe (S1612).

If a value of a relaying device field of the received NLIE is not 1 at step S1604, the device 411 determines whether an NL thereof is changed (S1614). If an NL thereof is changed, the device 411 generates an NLIE thereof (S1616), includes the generated NLIE in the beacon frame, and transmits the beacon frame at an allocated beacon slot within a beacon period of a next superframe (S1618).

If an NL thereof is not changed at step S1614, the device 411 stands by until a next superframe (S1620).

If the device 411 is a general device at step S1602, it determines whether an NL thereof is changed (S1614). If an NL thereof is changed, the device 411 generates an NLIE thereof (S1616), includes the generated NLIE in the beacon frame, and transmits the beacon frame at an allocated beacon slot within a beacon period of a next superframe (S1618).

That is, only when an NL is first generated or only when an NL thereof is changed due to addition or deletion of a new device does the device 411 generate and transmit an NLIE, and when the device 411 is a relaying device, it relays an NLIE that is transmitted by another relaying device.

In this way, when beacon groups of the n number are combined to form one extended beacon group, if superframes of the n number are passed through, all devices may collect all device information that is included in an extended beacon group.

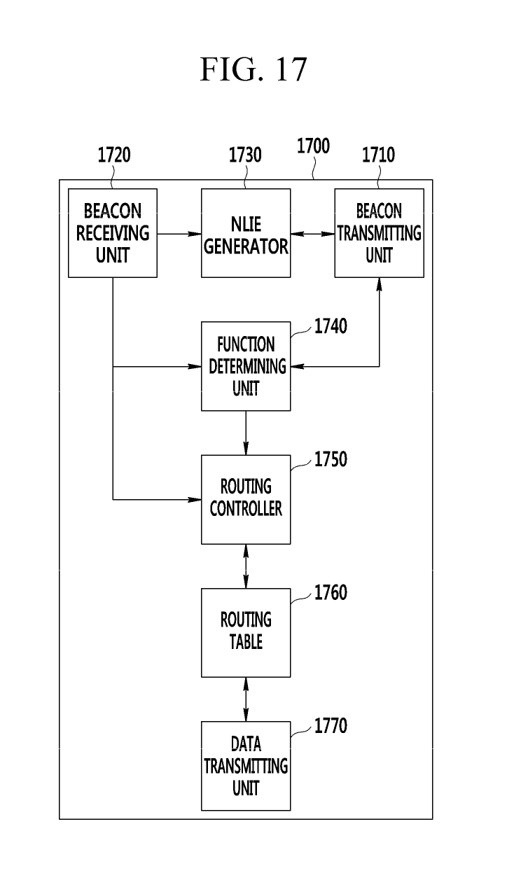

FIG. 17 is a block diagram illustrating a configuration of a routing apparatus according to an exemplary embodiment of the present invention, and hereinafter, a routing apparatus of the device 411 will be described.

Referring to FIG. 17, a routing apparatus 1700 of the device 411 includes a beacon transmitting unit 1710, a beacon receiving unit 1720, an NLIE generator 1730, a function determining unit 1740, a routing controller 1750, a routing table 1760, and a data transmitting unit 1770.

The beacon transmitting unit 1710 generates a beacon frame and transmits the beacon frame from an allocated beacon slot of the beacon period to a neighbor device. In this case, when an NL of the device 411 is changed, the beacon transmitting unit 1710 includes an NLIE of the device 411 in the beacon frame and transmits the beacon frame to neighbor devices 412, 413, and 414. Further, when the device 411 is a relaying device, the device 411 includes the received NLIE of the neighbor device in the beacon frame and transmits the beacon frame to the neighbor devices 412, 413, and 414.

The beacon receiving unit 1720 receives the beacon frame from the neighbor devices 412, 413, and 414. The beacon receiving unit 1720 determines a relaying device field of the received beacon frame, and when the relaying device field of the received beacon frame is 1, the beacon receiving unit 1720 transfers an NLIE that is included in the received beacon frame to the beacon transmitting unit 1710.

The NLIE generator 1730 generates an NL including an address thereof through a beacon frame that is received from the neighbor devices 412, 413, and 414 and generates an NLIE using the generated NL.

When an NL is firstly generated or when the generated NL is changed by comparison with a previously generated NL, the NLIE generator 1730 transfers an NLIE to the beacon transmitting unit 1710.

The function determining unit 1740 determines an NL of the neighbor devices 412, 413, and 414 from an NLIE of a beacon frame that is received from the neighbor devices 412, 413, and 414, obtains the difference sets of an NL thereof and NL of each of the neighbor devices 412, 413, and 414, and if all results are null sets, the function determining unit 1740 determines that the device 411 is a general device, and if results are not null sets, the function determining unit 1740 determines that the device 411 is a relaying device. The function determining unit 1740 transfers a determined function thereof to the NLIE generator 1730.

The NLIE generator 1730 sets a value of a relaying device subfield in the NLIE to correspond to the determined function.

The routing controller 1750 generates a routing table based on the above-described method using a beacon frame that it receives from the neighbor devices 412, 413, and 414, and when a function of all devices 411, 412, 413, 414, 421, 422, 423, 431, and 441 within an extended beacon group is determined, the routing controller 1750 updates a routing table of neighbor devices of an 1-hop distance and a 2-hop distance.

Further, the routing controller 1750 calculates a metric based on Equation 1 of each destination address and updates the routing table with the calculated metric value.

As shown in FIG. 8, the routing table 1760 includes a destination address field, a next hop address field, an available MAS number field, an In Use field, and a metric field.

The data transmitting unit 1770 transmits data to a destination with reference to a routing table, particularly, selects a relaying device that guarantees QoS with reference to a routing table, in order to transmit data to a destination.

According to an exemplary embodiment of the present invention, by selecting a relaying device within an extended beacon group, multi-hop communication between devices within the extended beacon group can be performed. Particularly, in consideration of RSSI, the available MAS number, and a hop count, by selecting a relaying device, QoS can be guaranteed.

An exemplary embodiment of the present invention may not only be embodied through the above-described apparatus and/or method but may also be embodied through a program that executes a function corresponding to a configuration of the exemplary embodiment of the present invention or through a recording medium on which the program is recorded, and can be easily embodied by a person of ordinary skill in the art from a description of the foregoing exemplary embodiment.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method of routing from a starting point device to a destination device in a first device within an extended beacon group, the method comprising:
generating a neighbor list (NL) of the device representing information of each neighbor device corresponding to a 1-hop distance of the device;
determining whether a function of the device is as a relaying device using the NL of the device and an NL of the each neighbor device; and
selecting, when a function of all devices within the extended beacon group is determined, a relaying device to transfer data to the destination device using a metric value representing quality of service (QoS).

2. The method of claim 1, wherein the generating of an NL comprises:
receiving a beacon frame from each neighbor device; and
generating the NL using a source address of the beacon frame.

3. The method of claim 2, wherein the beacon frame comprises an NL information element (NLIE), and
the NLIE comprises the NL of the neighbor device.

4. The method of claim 3, wherein the NLIE comprises:
a relaying device subfield representing a function of the neighbor device; and
a medium access slot (MAS) field representing the number of MASs that the neighbor device can use.

5. The method of claim 4, wherein the NLIE further comprises
a hop count subfield representing a hop count from a device that generates the NLIE to a device that receives the NLIE, and
the hop count increases by 1 whenever passing through a relaying device.

6. The method of claim 5, wherein the selecting of a relaying device comprises:
calculating a metric value of each of neighbor devices corresponding to a relaying device using an available MAS number, a received signal strength indication (RSSI) according to a transmission distance, and a hop count; and
selecting a neighbor device having a largest metric value among neighbor devices corresponding to the relaying device as the relaying device to transfer the data.

7. The method of claim 2, further comprising relaying, when the device is a relaying device, a beacon frame that is received from the each neighbor device to the neighbor device of the 1-hop distance.

8. The method of claim 1, wherein the determining of whether a function of the device is as a relaying device comprises:
obtaining difference sets of the NL of the device and the NL of the each neighbor device; and
determining, when all difference sets of the NL set and the NL set of each neighbor device are null sets, that a function of the device is as a relaying device.

9. The method of claim 1, further comprising:
generating an NLIE comprising the NL of the device; and
transmitting the NLIE at a next superframe through a beacon frame comprising the NLIE.

10. The method of claim 9, wherein the generating of an NLIE comprises generating the NLIE when the generated NL is changed.

11. The method of claim 9, wherein the NLIE comprises:
a relaying device subfield representing a function of the device; and
an MAS field representing the number of MASs that the device can use.

12. The method of claim 11, wherein the NLIE further comprises a hop count subfield representing a hop count from a device that generates the NLIE to a device that receives the NLIE, and
the hop count increases by 1 whenever passing through the relaying device.

13. A multi-hop QoS routing apparatus from a starting point device to a destination device of devices within an extended beacon group, the multi-hop QoS routing apparatus comprising:
a routing table comprising a destination address field, a next hop address field, and an available MAS number field;
a beacon receiving unit that receives a beacon frame from each neighbor device of a 1-hop distance;
a routing controller that records a source address of the received beacon frame at the destination address field and the next hop address field of the routing table and that records an address of a neighbor device of a 2-hop distance that is determined from the received beacon frame at a destination address field and that records a next hop address as a source address of the beacon frame; and
a data transmitting unit that selects a relaying device to transmit data to the destination device with reference to the routing table,
wherein the beacon frame comprises an NL representing information of a neighbor device of a 1-hop distance of a neighbor device of the 1-hop distance.

14. The multi-hop QoS routing apparatus of claim 13, further comprising:
an NLIE generator that generates an NL of the device from a beacon frame that is received from the neighbor device and that generates an NLIE comprising the NL; and
a beacon transmitting unit that transmits a beacon frame comprising the NLIE at an allocated MAS of a beacon period to a neighbor device of the 1-hop distance.

15. The multi-hop QoS routing apparatus of claim 14, further comprising a function determining unit that determines whether a function of the device is as a relaying device using an NL of the device and an NL of a neighbor device of the 1-hop distance,
wherein the NLIE comprises a relaying device subfield representing a function of the device.

16. The multi-hop QoS routing apparatus of claim 15, wherein the function determining unit determines that the device is a relaying device when all difference sets of the NL of the device and the NL of each neighbor device of the 1-hop distance are null sets.

17. The multi-hop QoS routing apparatus of claim 15, wherein the NLIE generator generates the NLIE when the NL is changed, and
the beacon transmitting unit transmits the received beacon frame to a neighbor device of the 1-hop distance when the device is a relaying device.

18. The multi-hop QoS routing apparatus of claim 17, wherein the NLIE further comprises:
a hop count subfield that represents a hop count from a device that generates the NLIE to a device that receives the NLIE; and
an MAS field that represents the number of MASs that the device can use,
wherein the hop count increases by 1 whenever passing through the relaying device.

19. The multi-hop QoS routing apparatus of claim 13, wherein the routing table further comprises a metric field, and
the routing controller calculates a metric value of each of neighbor devices corresponding to a relaying device using RSSI according to a transmission distance of each of neighbor devices, a hop count, and the available MAS number and records the metric value in the metric field, and selects a neighbor device having a largest metric value among neighbor devices corresponding to the relaying device as a relaying device to transfer the data.

20. The multi-hop QoS routing apparatus of claim 19, wherein the metric value is a value found by dividing the sum of a first value multiplied by a first weight value to the available MAS number and a second value multiplied by a second weight value to the RSSI, by the hop count, and
the sum of the first weight value and the second weight value is 1, while the first weight value is larger than the second weight value.
